(19) United States
(12) Patent Application Publication
(10) Pub. No.: US 2004/0140303 A1
(43) Pub. Date: Jul. 22, 2004

(54) Steel wire for carbon dioxide shielded arc welding and welding process using the same

(76) Inventors: Tokihiko Kataoka, Okayama (JP); Rinsei Ikeda, Okayama (JP); Koichi Yasuda, Okayama (JP); Kenji Tokinori, Okayama (JP)

Correspondence Address: IP DEPARTMENT OF PIPER RUDNICK LLP, ONE LIBERTY PLACE, SUITE 4900, 1650 MARKET ST, PHILADELPHIA, PA, 19103, US

(21) Appl. No.: 10/474,827

(22) PCT Filed: Jan. 22, 2003
(86) PCT No.: PCT/JP03/00528

(51) Int. Cl. B23K 9/173

(52) U.S. Cl. 219/137 WM; 219/74; 219/146.1

(57) ABSTRACT

In carbon dioxide arc welding by use of shielding gas comprised of carbon dioxide as main component, a welding wire that enables spray transfer of globules, and provides an excellent bead shape in addition to reduction of amount of spatters even in a high-speed welding, and a welding method using the welding wire are proposed.

As the specific means, a welding steel wire for use in carbon dioxide arc welding in DC-electrode negative, comprising a bar steel having a composition that contains 0.003 to 0.20% by mass of C, 0.05 to 2.5% by mass of Si, 0.25 to 3.5% by mass of Mn, 0.015 to 0.100% by mass of REM (rare-earth elements), 0.001 to 0.05% by mass of P, and 0.001 to 0.05% by mass of S, or further contains 0.0100% by mass or less of O, or further contains one or two or more of 0.02 to 0.50% by mass of Ti, 0.02 to 0.50% by mass of Zr, and 0.02 to 3.00% by mass of Al, or further contains 0.0001 to 0.0150% by mass of K, or further contains 3.0% by mass or less of Cr, 3.0% by mass or less of Ni, 1.5% by mass or less of Mo, 3.0% by mass or less of Cu, 0.015% by mass or less of B, 0.20% by mass or less of Mg, 0.5% by mass or less of Nb, 0.5% by mass or less of V, and 0.020% by mass or less of N, and contains Fe and unavoidable impurities as residue is used.

### TECHNICAL FIELD

This invention relates to a welding wire for use in the carbon-dioxide arc welding in DC-electrode negative, particularly relates to the welding wire for the carbon-dioxide arc welding (hereinafter referred to as “welding wire”) that provides spray transfer, which is regarded as the most stable transfer mode of globules when the welding wire is used in DC-electrode negative (or minus electrode), reduced amount of spatters, and an excellent bead shape.

### BACKGROUND ART

A gas shielded arc welding using CO₂ gas as a shielding gas is widely used for welding of steel materials, because the carbon-dioxide gas is inexpensive and the welding method is highly efficient. In particular, since an automatic welding has come into a widespread use rapidly, the welding method has been used in various fields such as shipbuilding, construction, bridges, automobiles, and building machinery. In the fields of the shipbuilding, construction, and bridges, the welding method is mostly used for a high-current multi-layer welding for thick sheets. In the fields of the automobiles and building machinery, the welding method is mostly used for lap welding for thin sheets.

A welding method using a mixed gas of Ar gas and CO₂ gas (mixing ratio of 2 to 40% by volume) as the shielding gas (so-called mixed gas arc welding) enables a fine spray transfer in which diameter of globules is smaller than that of the welding wire. The spray transfer of the globules is the most excellent mode among any transfer modes, and is known as a mode having reduced amount of spatters, an excellent welding bead shape, and as a mode suitable for high-speed welding. Therefore, the mixed gas arc welding has been used in a field requiring a high-quality welding.

However, since the cost of Ar gas is five times higher than that of CO₂ gas, in actual welding procedure, a mixed gas in which amount of Ar gas used is reduced and mixing ratio of CO₂ gas is 50% or more by volume is used as the shielding gas in most cases. When such shielding gas containing the mixing ratio of 50% or more by volume of CO₂ gas is used, a coarse globule, which is 10 to 20 times larger than that in a welding method (so-called mixed gas arc welding) using a shielding gas comprising Ar—CO₂ (mixing ratio of 2 to 40% by volume), suspends from an end of the welding wire, and transfers with being fluctuated by arc power (so-called globular transfer). When such globular transfer occurs, large amount of spatters due to short circuit with base metal (or steel sheet) or restrike of arc is generated, and thus the bead shape is unstable. Particularly, in the high-speed welding, there has been a problem that an irregular bead shape is easily formed (so-called humping bead).

For this problem, a method for reducing the amount of spatters by adding K is disclosed in unexamined Japanese Patent publication No.JP-A-6-218574. However, in this technique, effects on reduction of the amount of spatters and stabilization of the bead shape have not been always obtained when welding speed is increased, or when CO₂ in the shielding gas is increased to 50% or more by volume.

In unexamined Japanese Patent publication No.JP-A-7-47473 and unexamined Japanese Patent publication No.JP-A-7-290241, a carbon-dioxide pulse arc welding method, in which one pulse is generated within a transfer time of one globule, thereby the amount of spatters is reduced, is proposed. In MAG welding using a mixed gas comprising Ar—CO₂ (5 to 25% by volume) as the shielding gas, the one-pulse for one-globule transfer welding technique is established. In the technique, since the globules are fine and a downward plasma air stream is strong in the Ar—CO₂ (5 to 25% by volume) welding, the globules efficiently grow in a peak period and efficiently transfer in a base period. Moreover, time required for forming one globule is short as 1 to 2 ms, and even if the one globule does not transfer in one pulse, as long as the globule transfers in the next pulse, no large globule suspends from the wire end and an effect of pulses on reduction of the amount of spatters is exhibited. However, in a carbon-dioxide arc welding using a shielding gas containing CO₂ as a main component (a mixture ratio of the CO₂ gas is 50% or more by volume) in JP-A-7-47473 and JP-A-7-290241, the globules are coarse, the downward plasma air stream is weak, and the globules transfer in the first half of the peak period of pulses. In the carbon-dioxide arc welding, the globule grows through the middle and second half of the peak period, and it is considered as ideal that the globule always suspends from the wire end in the base period, and the globule transfers to a steel sheet side in the first half of the next peak period. The time for forming one globule is long, 10 to 20 ms, therefore when one globule doesn't transfer in one pulse, the globule transfers in the next pulse, and a coarse globule suspends from the wire end during the pulse period, and thus large amount of coarse spatters is generated due to the short circuit. In the carbon-dioxide pulse arc welding method, transfer interval of the globules is unstable, and it is difficult to generate one pulse stably in correspondence with the transfer time of one globule.

Although the inventors developed U.S. Ser. No. 10/107,623 (filed Mar. 27, 2002) entitled “STEEL WIRE FOR MAG WELDING AND MAG WELDING METHOD USING THE SAME”, the method is designed for a low-current (250 A or less) welding for thin steel sheets having a gap in the welding portion, and cannot provide the effect on the stabilization of arc sufficiently in a high-current (more than 250 A) welding in the carbon-dioxide arc welding.

Although unexamined Japanese Patent publication No.JP-A-63-281796 discloses an effect of addition of REM on the stabilization of arc in the carbon-dioxide arc welding, there is no disclosure on the welding wire in DC-electrode negative, which is the greatest feature of the invention. It is recognized that in the welding when the welding wire is negative, coarse globules compared with those in the carbon-dioxide arc welding when the welding wire is positive are formed, and thus further coarse spatters are generated due to an extensive short circuit, and the bead shape is uneven because of a coarse transfer mode of the globules, and welding defects due to overlap easily occur because heat generation is not much in a steel sheet side and penetration is shallow. Accordingly, welding engineers don't have an idea of using the welding wire in DC-electrode negative (or minus electrode), and it is a common sense that the wire is always positive (or the wire is plus electrode). However, there is no disclosure on polarity in JP-A-63-281796. In this case, the welding wire is considered to be either negative or positive. In case of the DC-electrode positive that is generally used in the carbon-dioxide arc welding method, it is known that the addition of REM causes pinching and rebounding of the arc, and thereby increases large particle of spatters, and thus the addition of REM doesn't provide effect on the stabilization of arc. In case of DC-electrode negative, there is no disclosure on important techniques regarding additive elements of P and S required for the stabilization of arc, as the feature herein, and O that reduces the spray transfer of the globules and the arc stabilizing effect in case of DC-electrode negative, and thus a sufficient effect on the stabilization of arc and an excellent bead shape can not be obtained in the carbon-dioxide arc.

As described above, when a shielding gas having more than 40% by volume of mixing ratio of CO₂ gas to Ar gas is used, compared with the typical mixed gas arc welding (mixing ratio of CO₂ gas of 2 to 40% by volume), a coarse globule suspends from the welding wire end and is fluctuated by the arc power. As a result, there has been a problem that the amount of spatters increases due to an irregular short circuit with the base metal (or steel sheet) or restrike of arc, and the bead shape is unstable in the high-speed welding.

When the shielding gas containing CO₂ gas as a main component (mixing ratio of CO₂ of more than 40% by volume) is used, the spray transfer of the globules must be achieved to solve such problem.

However, while the spray transfer of the globules is possible in the typical mixed gas arc welding (mixing ratio of CO₂ gas of 2 to 40% by volume), it has been extremely difficult to achieve the spray transfer in the welding using the shielding gas having more than 40% by volume of mixing ratio of CO₂ gas.

The invention, which was developed in view of the problem, aims to propose a welding wire that enables the spray transfer of the globules, and provides reduction of the amount of spatters, in addition, an excellent bead shape even if the high-speed welding is carried out in the carbon-dioxide arc welding using the shielding gas containing CO₂ gas as a main component (herein, the effect is particularly significant in more than 60% by volume of mixing ratio of CO₂), and a welding method using the welding wire.

In the invention, the carbon-dioxide arc welding is a welding method using a gas containing mainly CO₂ gas (more than 60% by volume of mixing ratio of CO₂) as a shielding gas, against the shielding gas comprising a mixture of Ar gas and CO₂ gas used in so-called mixed gas arc welding (2 to 40% by volume of mixing ratio of CO₂). The carbon-dioxide arc welding in the invention is a welding method using mainly CO₂ gas (so-called carbon-dioxide arc welding).

### DISCLOSURE OF THE INVENTION

The inventors carried out thorough research on the reduction of the amount of spatters and improvement of the bead shape in the carbon-dioxide arc welding using the shielding gas containing CO₂ as a main component (or 60% or more by volume of CO₂). As a result, views described below were obtained.

The inventors found the following:

1) The globules can be transferred stably by welding in DC-electrode negative, where the welding wire is minus electrode, though the globules are coarse.

2) An arc stop in a low voltage region is prevented and the globules can be transferred stably by adding rare-earth elements (hereinafter, referred to as “REM”) to the welding wire.

3) The penetration is ensured and thus the bead can be smoothened by adding REM to the welding wire.

4) An arc generation point in the negative electrode can be concentrated and stabilized by adding REM to the welding wire and defining contents of P, S, O, Ca, and K.

5) Further stable weldability is provided by adding Ti, Zr, and Al, which are strongly deoxidizing elements, to the welding wire.

The invention was made based on these views.

That is, the invention is a welding wire for use in the carbon-dioxide arc welding in DC-electrode negative, which contains 0.003 to 0.20% by mass of C, 0.05 to 2.5% by mass of Si, 0.25 to 3.5% by mass of Mn, 0.015 to 0.100% by mass of REM, 0.001 to 0.05% by mass of P, 0.001 to 0.05% by mass of S, and Fe and unavoidable impurities as residue.

In the welding steel wire for carbon-dioxide arc welding, as a preferred aspect, it is preferable that a bar steel contains 0.0100% by mass or less of Oand 0.0008% by mass or less of Ca in addition to the above composition, and further contains one or two or more of 0.02 to 0.50% by mass of Ti, 0.02 to 0.50% by mass of Zr, and 0.02 to 3.00% by mass of Al.

Moreover, in the invention, the wire composition further contains 3.0% by mass or less of Cr, 3.0% by mass or less of Ni, 1.5% by mass or less of Mo, 3.0% by mass or less of Cu, 0.015% by mass or less of B, 0.20% by mass or less of Mg, 0.5% by mass or less of Nb, 0.5% by mass or less of V, and 0.020% by mass or less of N.

Moreover, the invention is a carbon-dioxide arc welding method, in which the welding steel wire for the carbon-dioxide arc welding is used, a mixed gas of Ar gas and 60% by volume or more of mixing ratio of CO₂ gas or a 100% by volume of CO₂ gas shields the arc point, and the welding is performed in DC-electrode negative.

Here, the welding wire comprising the bar steel is a wire (so-called solid wire), which doesn't incorporate welding flux and comprises mainly bar steel as raw material. Moreover, the invention can be also applied without problem to the solid wire comprising a bar steel having a plated or lubricant-coated surface.

### BEST MODE FOR CARRYING OUT THE INVENTION

First, the reasons for setting the limits for the components of the bar steel as the raw material of the welding wire of the invention are described.

C: 0.003 to 0.20% by Mass

C is an important element for ensuring strength of the weld metal, and provides an effect on improvement of the fluidity of molten steel by decreasing viscosity of the molten steel. To obtain the effect, 0.003% by mass or more of C is necessary. When C content exceeds 0.20% by mass, behavior of the globules and molten pool becomes unstable, in addition, toughness of the weld metal decreases. Therefore, the C content was limited to 0.20% by mass or less. Thus, C must satisfy a range from 0.003 to 0.20% by mass. Further preferably, the C content is 0.01 to 0.10% by mass.

Si: 0.05 to 2.5% by Mass

Si has a deoxidizing effect and is an essential element for deoxidization of the weld metal. When Si content is less than 0.05% by mass, the deoxidization of the weld metal is insufficient, and thus blowholes are generated in the weld metal. Furthermore, to suppress spreading of arc in the welding in DC-electrode negative, and to increase the number of transfer of the globules, 0.25% by mass or more of Si is desirable. On the other hand, when the Si content exceeds 2.5% by mass, toughness of the weld metal significantly decreases. Therefore, Si must satisfy a range from 0.05 to 2.5% by mass. Further preferably, 0.25 to 2.5% by mass is desirable.

Mn: 0.25 to 3.5% by Mass

Mn has a deoxidizing effect like Si, and is an essential element for the deoxidization of the molten metal. When Mn content is less than 0.25% by mass, the molten metal is insufficiently deoxidized, and the blowholes are generated in the weld metal. Preferably, 0.45% by mass or more is desirable. On the other hand, when the Mn content exceeds 3.5% by mass, the toughness of the weld metal decreases. Therefore, Mn must satisfy a range from 0.25 to 3.5% by mass. Further preferably, 0.45 to 3.5% by mass is desirable.

REM: 0.015 to 0.100%

Rare-earth elements (or REM) are useful for refining inclusions in steel making and casting, and for improving the toughness. However, in the typical carbon-dioxide arc welding in DC-electrode positive (or welding wire is plus electrode), the effect on the reduction of the amount of spatters can not be obtained because of arc concentration. However, in the carbon-dioxide arc welding in DC-electrode negative (or welding wire is minus electrode), the rare-earth elements are essential for stabilizing the transfer of the globules. When REM content is less than 0.015%, the effect is not exhibited. When more than 0.100% of REM is added, cracks may occur during a wire fabrication process and the toughness of the weld metal decreases. Accordingly, the REM content must satisfy a range from 0.015 to 0.100%. Preferably, the REM content is 0.025 to 0.050%.

The term, rare-earth elements (or REM), is a general term of elements that belong to Group 3 in the periodic table. In the invention, elements of atomic Nos. 57 to 71 are preferably used, particularly Ce and La are preferable. When these elements are used in a mixed condition, a mixture containing 45 to 80% of Ce and 10 to 45% of La is preferable. (REM: atomic Nos. 57 to 71, main components: 45 to 80% by mass of Ce and 10 to 45% by mass of La)

P: 0.001 to 0.050% by Mass or Less

P lowers the melting point of steel and increases the electrical resistivity, and thus improves a melting efficiency. Furthermore, P refines the globules and stabilizes the arc in the carbon-dioxide arc welding in DC-electrode negative. When P content is less than 0.001% by mass, such effects cannot be obtained. When the P content exceeds 0.050% by mass, the viscosity of the molten metal is excessively lowered, thereby the arc becomes unstable in the carbon-dioxide arc welding in DC-electrode negative, and thus small particle of spatters are generated heavily, in addition, possibility of hot cracks in the weld metal is increased. Therefore, P was determined to be 0.050% by mass or less. More preferably, the P content is 0.002% by mass or more and 0.030% by mass or less.

S: 0.001 to 0.050% by Mass or Less

S reduces the viscosity of the molten metal, helps release of the globule suspended from the wire end, and stabilizes the arc in the carbon-dioxide arc welding in DC-electrode negative. Moreover, S spreads the arc and reduces the viscosity of the molten metal, thereby smoothen the bead in the welding in DC-electrode negative. When S content is less than 0.001% by mass, such effects cannot be obtained. When the S content exceeds 0.050% by mass, small particle of spatters are generated, in addition, the toughness of the weld metal is decreased. Therefore, S was determined to be 0.050% or less. More preferably, the S content is 0.002 to 0.030% by mass. Further preferably, the S content is 0.015 to 0.03% by mass.

O: 0.0100% by Mass or Less

O destabilizes the arc point generated on the globule suspended from the welding wire end, and increases the fluctuation of the globule, thereby increases the amount of spatters in the carbon-dioxide arc welding in DC-electrode negative (welding wire is minus electrode). Moreover, O reduces the effects of REM in DC-electrode negative on facilitation of the spray transfer of globules and the stabilization of arc.

More than 0.0100% by mass of O content destabilizes the arc point, and generates an unnecessary globule fluctuation, thereby increases the amount of spatters in the carbon-dioxide arc welding in DC-electrode negative. Therefore, O must satisfy a content of 0.0100% by mass or less. More preferably, the O content is adjusted to be 0.0030% by mass or less.

Ca: 0.0008% by Mass or Less

Ca is an impurity, which contaminates into the molten steel during the steel-making and casting, or contaminates into the bar steel during wire drawing process. However, in the carbon-dioxide arc welding in DC-electrode negative, Ca has a function of inhibiting the stability of the spray transfer in high-current welding. When Ca content exceeds 0.0008% by mass, Ca inhibits the stable spray transfer provided by the addition of REM. Therefore, the Ca content is preferably 0.0008% by mass or less.

K: 0.0001 to 0.0150% by Mass

K is an element that spreads the arc, enables the spray transfer of the globules even in low current welding, and has a function of refining the globule itself in the carbon-dioxide arc welding in DC-electrode negative. Therefore, K is added to the bar steel as needed. However, when K is added, in case of less than 0.0001% by mass of K, these effects cannot be obtained. On the other hand, when the K content exceeds 0.0150% by mass, arc length is elongated in welding, thereby the globule suspended from the welding wire end becomes unstable, and thus large amount of spatters are generated. Therefore, when K is added, it is preferable that K satisfies a range from 0.0001 to 0.0150% by mass. More preferably, the K content is 0.0003 to 0.0030% by mass. Since K has a low boiling point of about 760C, when K is added in a step for producing the steel materials, process yield is significantly decreased. Therefore, a potassium salt solution is applied on a surface of the bar steel and then annealing is carried out in a step for producing the bar steel, thereby K can be stably contained in the bar steel.

It is preferable in the invention that the composition of the bar steel further contains, in addition to the above composition, one or two or more of 0.02 to 0.50% by mass of Ti, 0.02 to 0.50% by mass of Zr, and 0.02 to 3.00% by mass of Al. The reasons for it are described.

Each of Ti, Zr, and Al is an element that acts as a strong deoxidizing agent, and increases the strength of the weld metal. Furthermore, the element has a function of stabilizing the bead shape (or suppressing the humping bead) by increasing the viscosity of the metal by deoxidizing the molten metal. Since the element has such effects, the element is effective in the high-current welding of 300 A or more, and added as needed. When Ti content is less than 0.02% by mass, Zr content is less than 0.02% by mass, or Al content is less than 0.02% by mass, the effects cannot be obtained. On the other hand, when Ti content exceeds 0.50% by mass, Zr content exceeds 0.50% by mass, or Al content exceeds 3.00% by mass, the globules become coarse, and large particle of spatters are generated in large quantity. Therefore, when Ti, Zr, or Al is added, it is preferable to satisfy a range of 0.02 to 0.50% by mass of Ti, 0.02 to 0.50% by mass of Zr, or 0.02 to 3.00% by mass of Al.

Even when following elements are further contained as needed, the advantages of the invention are not be reduced:

3.0% by mass or less of Cr, 3.0% by mass or less of Ni, 1.5% by mass or less of Mo, 3.0% by mass or less of Cu, 0.015% by mass or less of B, 0.20% by mass or less of Mg, 0.5% by mass or less of Nb, 0.5% by mass or less of V, and 0.020% by mass or less of N.

Each of Cr, Ni, Mo, Cu, B, and Mg is an element that increases the strength of the weld metal, and improves weather resistance. When a content of the element is small, such effects cannot be obtained. On the other hand, excessively large content causes decrease in the toughness of the weld metal. Therefore, when Cr, Ni, Mo, Cu, B, or Mg is contained, it is preferable to satisfy a range of 0.02 to 3.0% by mass of Cr, 0.05 to 3.0% by mass of Ni, 0.05 to 1.5% by mass of Mo, 0.05 to 3.0% by mass of Cu, 0.0005 to 0.015% by mass of B, or 0.001 to 0.20% by mass of Mg.

Each of Nb and V is an element that increases the strength and toughness of the weld metal, and improves the stability of the arc. When content of the element is small, such effects cannot be obtained. On the other hand, excessively large content of the element causes decrease in the toughness of the weld metal. Therefore, when Nb or V is contained, it is preferable to satisfy a range of 0.005 to 0.5% by mass of Nb or 0.005 to 0.5% by mass of V respectively.

The residue other than the components of the bar steel comprises Fe and the unavoidable impurities. For example, N, which is a typical, unavoidable impurity and contaminates in a step for producing the steel materials or in a step for producing the bar steel, is preferably reduced to 0.020% by mass or less.

Next, a method for producing the welding wire of the invention is described.

An ingot having the above composition is produced using a converter or an electric furnace. As the production method of the ingot, not limited to a particular technique, any of conventionally known techniques can be used. Then, the resultant ingot is formed into steel materials (for example, billet) by a continuous casting method or an ingot making process. The steel materials are heated, then subjected to hot rolling, and then subjected to a dry cold-rolling (in other words, wire-drawing), thereby the bar steel is produced. Operation conditions of the hot rolling or cold rolling are not limited particularly, and may be any of conditions as long as the conditions are those for producing a bar steel having a desired size and shape.

Then, the bar steel is subjected to processes of annealing, pickling, copper plating, wire drawing, and application of lubricant as needed, and formed into a specified product or welding wire.

In the carbon-dioxide arc welding in DC-electrode negative, the arc tends to be unstable due to a bad power supply compared with that in DC-electrode positive. However, by performing Cu plating 0.6 m or more in thickness on the surface of the bar steel, the bad power supply can be prevented. A thickness of 0.8 m or more of Cu plating is further preferable because the effect on the prevention of the bad power supply is significant. Thus, by increasing the thickness of Cu plating, an advantage of reduction of wear of a power supply tip is also obtained.

However, when Cu content in the bar steel and Cu content in the plating layer on its surface exceeds 3.0% by mass in total, the toughness of the weld metal decreases significantly. Therefore, it is preferable that the Cu content in the welding wire (or total amount of Cu in the bar steel and Cu in the plating layer) is 3.0% by mass or less.

To improve stability of the power supply and facilitate the spray transfer of the globules, it is important to set a surface flatness of the welding wire (or actual-surface-area/theoretical-surface-area) to be less than 1.01. The surface flatness of the welding wire can be kept to be less than 1.01 by performing a dice control securely in wire-drawing process of the steel composition.

By using a welding wire comprising a bar steel having a surface on which lubricating oil is applied, or a welding wire comprising a bar steel having a surface subjected to the Cu plating on which the lubricating oil is applied, performance of feeding of the welding wire can be improved. The application amount of the lubricant preferably satisfies a range from 0.35 to 1.7 g for 10 kg of the welding wire.

In this way, various impurities are adhered on the surface of the welding wire during fabrication of the welding wire. Particularly, by controlling the amount of adhered solid impurities to 0.01 g or less for 10 kg of the welding wire, the stability of the power supply is further improved.

Next, as preferred welding conditions in the carbon dioxide arc welding method in DC-electrode negative when the welding wire of the invention is used, it is desirable to perform the welding under the conditions that the shielding gas is 100% by volume of CO₂ or mixed gas of 40% by volume or less of Ar and 60% by volume or more of CO₂, and as other aptitude conditions, welding current is 250 to 450 A, welding voltage is 27 to 38 V (increase with increase of current), welding speed is 20 to 250 cm/min, wire extension is 15 to 30 mm, wire diameter is 0.8 to 1.6 mm, and welding heat input is 5 to 40 kJ/cm. In case of a thick sheet having a thickness of 10 mm or more, multi-layer welding can be used.

As the steel materials for welding, while not particularly limited, rolled steel for welded structure (SM material) defined by JIS G3106 and steel for building construction (SN material) defined by JIS G3136, which are Si—Mn steel alloys, are particularly preferable.

### EXAMPLE 1

A billet produced by the continuous casting was subjected to hot rolling, and a wire rod having a diameter of 5.5 to 7.0 mm was formed. Then, the wire rod was subjected to cold rolling (in other words, wire-drawing), and a bar steel having a diameter of 2.0 to 2.8 mm was formed, and then an aqueous tripotassium citrate solution in the quantity of 2 to 30% by volume was applied with an application amount of 30 to 50 g for 1 kg of bar steel.

Then, the bar steel was annealed in a nitrogen atmosphere containing 200 ppm by volume or less of O₂ and 0.1% by volume or less of CO₂ with a dew point of −2C or less. At this time, by controlling the diameter of the bar steel, concentration of the potassium citrate salt solution, annealing temperature, and annealing time, internal oxidization of the bar steel is controlled, thereby the K content and O content in the bar steel were adjusted.

After annealing was performed in this manner, the bar steel was subjected to acid pickling, then the surface of the bar steel was subjected to Cu-plating as needed. Then, the wire-drawing process (wet wire-drawing) was performed in cold working, and a welding wire having a diameter of 0.8 to 1.6 mm was produced. Lubricating oil was applied on the surface of the welding wire (0.4 to 0.8 g for 10 kg of welding wire). An adjustment for ensuring a sufficient feeding performance by the wire-drawing was carried out.

The resultant compositions of the bar steels of the welding wires are shown in Table 1, 2, and 3.

A carbon dioxide arc welding in DC-electrode negative was performed using the welding wires, and the transfer mode of the globules and the bead shape were examined. The results are shown in Table 4.

The transfer mode of the globules and the bead shape were evaluated according to the following procedure.

(A) Transfer Mode of Globules

A bead-on welding was performed in extension of 20 mm, welding speed of 40 cm/min, and arc voltage of 30 V using a steel sheet (corresponding to JIS G3106; SM490B) with thickness of 19 mm, width of 70 mm, and length of 500 mm. Evaluation was conducted as follows: a case that the spray transfer is confirmed at a welding current of 230 A is excellent (⊚), a case that the spray transfer is confirmed at a welding current of 250 A is good (O), a case that the spray transfer is confirmed at a welding current of 270 A is fair(Δ), and a case that the spray transfer is not confirmed even at a welding current of 300 A is bad (X).

(B) Bead Shape

A bead-on welding was performed in the extension of 20 mm, welding speed of 40 cm/min, arc voltage of 30 V, and welding current of 300 A using the steel sheet (corresponding to JIS G3106; SM 490B) with thickness of 19 mm, width of 70 mm, and length of 500 mm. After the welding was completed, irregularities in the center of the weld bead were measured in a distance of 10 cm in the longitudinal direction. Evaluation was conducted as follows: a case that 0.5 mm or more in length of the irregularities appeared five times or more was bad (X), and other cases were good (O).

Common welding conditions used in the welding tests are shown in the column of example 1 in Table 5.

As apparent from Table 4, a stable spray transfer was possible in the example of the invention. In particular, by setting the REM content to be 0.015% by mass or more and O content to be 0.0100% by mass or less in the bar steel, the spray transfer was enabled in a low current. By setting K content to be 0.0001% by mass or more, the spray transfer was enabled in a further low current.

By setting the content or contents of at least one or more of Ti, Zr, and Al in the bar steel to be 0.02% by mass or more respectively, an excellent bead shape was obtained. On the other hand, in a comparative example where the composition of the bar steel are departed from the scope of the invention, the spray transfer was not confirmed even at a welding current of 350 A.

### EXAMPLE 2

Carbon dioxide arc welding tests in DC-electrode negative were conducted using the steel wires shown in Table 1, 2, and 3 in the example 1, and amount of spatters was measured. The results are shown in Table 4. Common welding conditions used in the welding tests are shown in the column of example 2 in Table 5.

(1) Measurement of Amount of Spatters

A carbon-dioxide arc bead-on plate welding was performed in the extension of 20 mm, speed of 20 cm/min, welding current of 300 A, and arc voltage of 30 V on SM490B (JIS G3106) steel sheet with thickness of 19 mm, width of 70 mm, and length of 300 mm, and the amount of spatters was measured. Evaluation was conducted as follows: a case that the amount of spatters was 0.3 g/min or less was good (O), a case that the amount of spatters was more than 0.3 g/min and 0.6 g/min or less was good (Δ), and a case that the amount of spatters was more than 0.6 g/min was bad (X). The results are shown together in Table 3.

Industrial Applicability

According to the invention, the spray transfer of the globules and extremely small amount of spatters, which have been considered as impossible in the carbon dioxide arc welding, can be achieved, thereby a stable joint welding for thick steel sheets is enabled.

TABLE 1

| Wire | Bar Steel Composition (% by mass) | | | | | | | | | |
|---|---|---|---|---|---|---|---|---|---|---|
| No. | C | Si | Mn | P | S | Cr | Ni | Mo | Cu | B |
| 1 | 0.035 | 0.65 | 1.85 | 0.004 | 0.008 | 0.01 | 0.02 | 0.02 | 0.02 | 0.0002 |
| 2 | 0.054 | 0.55 | 1.42 | 0.003 | 0.006 | 0.05 | 0.02 | 0.02 | 0.02 | 0.0001 |
| 3 | 0.062 | 0.56 | 1.45 | 0.006 | 0.009 | 0.15 | 0.02 | 0.16 | 0.02 | 0.0020 |
| 4 | 0.009 | 0.58 | 1.50 | 0.003 | 0.003 | 0.02 | 0.02 | 0.17 | 0.02 | 0.0035 |
| 5 | 0.004 | 0.53 | 1.44 | 0.001 | 0.001 | 0.03 | 0.02 | 0.02 | 0.02 | 0.0006 |
| 6 | 0.006 | 0.65 | 1.95 | 0.005 | 0.007 | 0.15 | 0.50 | 0.45 | 0.02 | 0.0052 |
| 7 | 0.042 | 0.68 | 2.02 | 0.005 | 0.006 | 0.15 | 0.02 | 0.16 | 0.01 | 0.0021 |
| 8 | 0.044 | 0.72 | 2.25 | 0.006 | 0.004 | 0.02 | 0.02 | 0.02 | 0.02 | 0.0016 |
| 9 | 0.010 | 0.36 | 1.35 | 0.005 | 0.007 | 0.02 | 0.02 | 0.03 | 0.02 | 0.0001 |
| 10 | 0.055 | 0.88 | 1.85 | 0.003 | 0.018 | 0.02 | 0.02 | 0.02 | 0.35 | 0.0001 |
| 11 | 0.085 | 0.85 | 1.25 | 0.002 | 0.016 | 0.02 | 0.02 | 0.02 | 0.01 | 0.0002 |
| 12 | 0.105 | 1.23 | 2.01 | 0.015 | 0.021 | 0.02 | 0.02 | 0.02 | 0.02 | 0.0004 |
| 13 | 0.025 | 2.50 | 2.85 | 0.050 | 0.016 | 0.02 | 0.03 | 0.15 | 0.03 | 0.0006 |
| 14 | 0.052 | 1.24 | 1.85 | 0.005 | 0.001 | 0.10 | 0.02 | 0.15 | 0.03 | 0.0015 |
| 15 | 0.052 | 1.36 | 3.50 | 0.028 | 0.050 | 0.02 | 0.02 | 0.02 | 0.01 | 0.0007 |
| 16 | 0.042 | 0.70 | 1.70 | 0.003 | 0.008 | 0.02 | 0.02 | 0.02 | 0.02 | 0.0002 |

| Wire | Bar Steel Composition (% by mass) | | | | | | | | | Plating | |
|---|---|---|---|---|---|---|---|---|---|---|---|
| No. | K | Ca | N | O | Ti | Zr | Al | REM | Mg, Nb, V | Thickness (μm) | Remarks |
| 1 | <0.0001 | 0.0003 | 0.0024 | 0.0024 | 0.18 | 0.003 | 0.005 | 0.024 | — | No plating | Example of |
| 2 | <0.0001 | 0.0001 | 0.0035 | 0.0026 | 0.10 | — | 0.004 | 0.021 | — | 0.32 | the Invention |
| 3 | <0.0001 | 0.0002 | 0.0041 | 0.0027 | 0.09 | — | 0.003 | 0.019 | — | 0.45 | |
| 4 | <0.0001 | <0.0001 | 0.0031 | 0.0033 | 0.12 | — | 0.003 | 0.015 | V = 0.02 | 0.58 | |
| 5 | <0.0001 | 0.0002 | 0.0033 | 0.0031 | 0.15 | — | 0.006 | 0.015 | — | 0.42 | |
| 6 | <0.0001 | 0.0006 | 0.0030 | 0.0022 | 0.19 | — | 0.004 | 0.024 | — | 0.60 | |
| 7 | <0.0001 | 0.0004 | 0.0026 | 0.0019 | 0.15 | 0.02 | 0.003 | 0.023 | — | 0.57 | |
| 8 | <0.0001 | 0.0008 | 0.0023 | 0.0030 | 0.18 | 0.001 | 0.007 | 0.017 | Nb = 0.01 | 0.55 | |
| 9 | <0.0001 | <0.0001 | 0.0027 | 0.0033 | 0.001 | — | 0.002 | 0.024 | Nb = 0.03 | 0.45 | |
| 10 | <0.0001 | 0.0002 | 0.0040 | 0.0024 | 0.15 | — | 0.240 | 0.018 | — | 0.53 | |
| 11 | <0.0001 | 0.0003 | 0.0025 | 0.0015 | 0.01 | — | 0.004 | 0.015 | — | 0.39 | |
| 12 | <0.0001 | 0.0005 | 0.0054 | 0.0012 | 0.13 | — | 0.003 | 0.020 | — | 0.52 | |
| 13 | <0.0001 | 0.0002 | 0.0052 | 0.0010 | 0.25 | — | 0.012 | 0.023 | — | 0.54 | |
| 14 | <0.0001 | 0.0008 | 0.0059 | 0.0016 | 0.30 | — | 0.015 | 0.024 | — | 0.63 | |
| 15 | <0.0001 | 0.0005 | 0.0030 | 0.0024 | 0.20 | — | 0.035 | 0.020 | — | 0.73 | |
| 16 | <0.0001 | 0.0003 | 0.0038 | 0.0022 | 0.20 | — | 0.003 | 0.019 | — | 0.64 | |

TABLE 2

| Wire | Bar Steel Composition (% by mass) | | | | | | | | | |
|---|---|---|---|---|---|---|---|---|---|---|
| No. | C | Si | Mn | P | S | Cr | Ni | Mo | Cu | B |
| 17 | 0.032 | 0.56 | 1.45 | 0.007 | 0.008 | 0.02 | 1.00 | 0.38 | 0.02 | 0.0033 |
| 18 | 0.003 | 0.61 | 1.40 | 0.006 | 0.013 | 0.02 | 0.85 | 0.32 | 0.03 | 0.0029 |
| 19 | 0.041 | 0.58 | 1.42 | 0.004 | 0.021 | 0.25 | 0.43 | 0.28 | 0.01 | 0.0031 |
| 20 | 0.045 | 0.43 | 1.25 | 0.002 | 0.018 | 0.02 | 0.02 | 0.02 | 0.01 | <0.0001 |
| 21 | 0.112 | 0.63 | 1.45 | 0.006 | 0.007 | 0.02 | 0.02 | 0.02 | 0.02 | 0.0004 |
| 22 | 0.024 | 0.36 | 1.40 | 0.005 | 0.002 | 0.02 | 0.03 | 0.02 | 0.03 | 0.0006 |
| 23 | 0.035 | 0.55 | 1.45 | 0.005 | 0.015 | 0.10 | 0.02 | 0.18 | 0.05 | 0.0025 |
| 24 | 0.085 | 0.05 | 0.25 | 0.008 | 0.002 | 0.02 | 0.02 | 0.02 | 0.01 | 0.0002 |
| 25 | 0.053 | 0.42 | 2.13 | 0.004 | 0.015 | 0.02 | 0.02 | 0.02 | <0.01 | 0.0007 |
| 26 | 0.042 | 0.65 | 1.70 | 0.003 | 0.008 | 0.02 | 0.02 | 0.02 | 0.02 | 0.0002 |
| 27 | 0.045 | 0.55 | 1.25 | 0.005 | 0.017 | 0.02 | 0.02 | 0.35 | 0.01 | 0.0024 |
| 28 | 0.060 | 0.63 | 1.64 | 0.006 | 0.018 | 0.02 | 0.02 | 0.02 | 0.01 | 0.0003 |
| 29 | 0.035 | 0.56 | 1.42 | 0.005 | 0.003 | 0.02 | 0.02 | 0.03 | 0.01 | 0.0001 |
| 30 | 0.065 | 0.56 | 1.43 | 0.003 | 0.004 | 0.02 | 0.02 | 0.02 | 0.03 | 0.0002 |

| Wire | Bar Steel Composition (% by mass) | | | | | | | | | Plating | |
|---|---|---|---|---|---|---|---|---|---|---|---|
| No. | K | Ca | N | O | Ti | Zr | Al | REM | Mg, Nb, V | Thickness (μm) | Remarks |
| 17 | 0.0002 | 0.0003 | 0.0021 | 0.0063 | 0.13 | — | 0.005 | 0.036 | V = 0.05 | 0.81 | Example of |
| 18 | 0.0006 | 0.0001 | 0.0025 | 0.0073 | 0.15 | — | 0.005 | 0.042 | — | 0.80 | the Invention |
| 19 | 0.0008 | 0.0002 | 0.0026 | 0.0066 | 0.14 | — | 0.003 | 0.033 | — | 0.86 | |
| 20 | 0.0005 | 0.0003 | 0.0023 | 0.0050 | 0.02 | — | 0.012 | 0.045 | | 0.91 | |
| 21 | 0.0006 | <0.0001 | 0.0054 | 0.0085 | 0.05 | — | 0.003 | 0.031 | — | 0.75 | |
| 22 | 0.0015 | 0.0002 | 0.0052 | 0.0025 | 0.09 | — | 0.012 | 0.033 | — | 0.87 | |
| 23 | 0.0008 | 0.0005 | 0.0038 | 0.0067 | 0.16 | — | 0.005 | 0.065 | — | 0.91 | |
| 24 | 0.0006 | 0.0001 | 0.0036 | 0.0026 | 0.16 | — | 0.042 | 0.052 | — | 0.84 | |
| 25 | 0.0003 | 0.0003 | 0.0030 | 0.0090 | 0.17 | — | 0.035 | 0.026 | — | 0.92 | |
| 26 | 0.0004 | 0.0003 | 0.0038 | 0.0022 | 0.07 | — | 0.003 | 0.028 | — | 0.64 | |
| 27 | 0.0007 | 0.0004 | 0.0036 | 0.0070 | 0.17 | — | 0.024 | 0.040 | — | 0.85 | |
| 28 | 0.0004 | 0.0005 | 0.0015 | 0.0043 | 0.12 | — | 0.006 | 0.066 | — | 0.65 | |
| 29 | 0.0007 | 0.0005 | 0.0044 | 0.0021 | 0.15 | — | 0.500 | 0.078 | — | 0.62 | |
| 30 | 0.0005 | 0.0006 | 0.0042 | 0.0063 | 0.17 | — | 0.008 | 0.100 | — | 0.68 | |

TABLE 3

| Wire | Bar Steel Composition (% by mass) | | | | | | | | | |
|---|---|---|---|---|---|---|---|---|---|---|
| No. | C | Si | Mn | P | S | Cr | Ni | Mo | Cu | B |
| 31 | 0.025 | 0.85 | 1.35 | 0.002 | 0.018 | 0.01 | 0.01 | 0.01 | 0.02 | <0.0001 |
| 32 | 0.080 | 0.95 | 1.45 | 0.003 | 0.012 | 0.02 | 0.02 | 0.02 | 0.02 | <0.0001 |
| 33 | 0.038 | 0.65 | 1.65 | 0.001 | 0.011 | 0.02 | 0.02 | 0.02 | 0.02 | <0.0001 |
| 34 | 0.025 | 0.55 | 1.35 | <0.0005 | 0.024 | 0.02 | 0.02 | 0.02 | 0.02 | <0.0001 |
| 35 | 0.054 | 0.42 | 1.45 | 0.065 | 0.035 | 0.02 | 0.02 | 0.02 | 0.02 | <0.0001 |
| 36 | 0.033 | 0.50 | 1.75 | 0.005 | <0.0005 | 0.02 | 0.02 | 0.02 | 0.02 | <0.0001 |
| 37 | 0.048 | 0.52 | 1.45 | 0.001 | 0.058 | 0.02 | 0.02 | 0.02 | 0.02 | <0.0001 |

| Wire | Bar Steel Composition (% by mass) | | | | | | | | | Plating | |
|---|---|---|---|---|---|---|---|---|---|---|---|
| No. | K | Ca | N | O | Ti | Zr | Al | REM | Mg, Nb, V | Thickness (μm) | Remarks |
| 31 | <0.0001 | 0.0002 | 0.0045 | 0.0168 | 0.04 | — | 0.003 | 0.003 | — | 0.44 | Comparative |
| 32 | <0.0001 | 0.0001 | 0.0035 | 0.0142 | 0.08 | — | 0.005 | 0.003 | — | 0.41 | Example |
| 33 | <0.0001 | 0.0010 | 0.0045 | 0.0124 | 0.18 | — | 0.004 | 0.014 | — | 0.35 | |
| 34 | <0.0001 | 0.0024 | 0.0065 | 0.0156 | 0.05 | — | 0.007 | 0.017 | — | 0.24 | |
| 35 | <0.0001 | 0.0032 | 0.0042 | 0.0168 | 0.18 | — | 0.004 | 0.019 | — | 0.35 | |
| 36 | <0.0001 | 0.0024 | 0.0048 | 0.0250 | 0.19 | — | 0.007 | 0.020 | — | 0.28 | |
| 37 | <0.0001 | 0.0065 | 0.0024 | 0.0138 | 0.13 | — | 0.004 | 0.021 | — | 0.32 | |

TABLE 4

| | | | Evalu- | | | |
|---|---|---|---|---|---|---|
| | Spray Transfer | | ation | Spatter | | |
| Wire | Critical | | of Bead | Amount | | |
| No. | Current | Evaluation | Shape | (g/min) | Evaluation | Remarks |
| 1 | 260 | Δ | ∘ | 0.35 | Δ | Example of |
| 2 | 270 | Δ | ∘ | 0.41 | Δ | the Invention |
| 3 | 280 | Δ | ∘ | 0.51 | Δ | |
| 4 | 290 | Δ | ∘ | 0.56 | Δ | |
| 5 | 300 | Δ | ∘ | 0.58 | Δ | |
| 6 | 260 | Δ | ∘ | 0.33 | Δ | |
| 7 | 260 | Δ | ∘ | 0.36 | Δ | |
| 8 | 270 | Δ | ∘ | 0.50 | Δ | |
| 9 | 260 | Δ | X | 0.48 | Δ | |
| 10 | 270 | Δ | ∘ | 0.52 | Δ | |
| 11 | 300 | Δ | X | 0.57 | Δ | |
| 12 | 270 | Δ | ∘ | 0.55 | Δ | |
| 13 | 260 | Δ | ∘ | 0.39 | Δ | |
| 14 | 270 | Δ | ∘ | 0.33 | Δ | |
| 15 | 270 | Δ | ∘ | 0.44 | Δ | |
| 16 | 270 | Δ | ∘ | 0.50 | Δ | |
| 17 | 240 | ∘ | ∘ | 0.27 | ∘ | |
| 18 | 230 | ⊚ | ∘ | 0.21 | ∘ | |
| 19 | 240 | ∘ | ∘ | 0.26 | ∘ | |
| 20 | 220 | ⊚ | ∘ | 0.19 | ∘ | |
| 21 | 230 | ⊚ | ∘ | 0.22 | ∘ | |
| 22 | 240 | ∘ | ∘ | 0.26 | ∘ | |
| 23 | 220 | ⊚ | ∘ | 0.20 | ∘ | |
| 24 | 220 | ⊚ | ∘ | 0.21 | ∘ | |
| 25 | 250 | ∘ | ∘ | 0.26 | ∘ | |
| 26 | 250 | ∘ | ∘ | 0.25 | ∘ | |
| 27 | 230 | ⊚ | ∘ | 0.20 | ∘ | |
| 28 | 220 | ⊚ | ∘ | 0.18 | ∘ | |
| 29 | 220 | ⊚ | ∘ | 0.24 | ∘ | |
| 30 | 220 | ⊚ | ∘ | 0.27 | ∘ | |
| 31 | >350 | x | x | 1.54 | x | Comparative |
| 32 | >350 | x | x | 1.37 | x | Example |
| 33 | >350 | x | x | 2.58 | x | |
| 34 | >350 | x | x | 2.35 | x | |
| 35 | >350 | x | x | 1.95 | x | |
| 36 | >350 | x | x | 3.24 | x | |
| 37 | >350 | x | x | 1.75 | x | |

TABLE 5

| | | Example 1 | Example 2 |
|---|---|---|---|
| Steel | Steel Type | SM490B | SM490B |
| Plate | Thickness | 19 mm | 19 mm |
| | Width | 70 mm | 70 mm |
| | Length | 500 mm | 300 mm |
| Welding | Shielding Gas | | |
| | Type | 100% CO₂ | 100% CO₂ |
| | Flow Rate | 20 litter/min | 20 litter/min |
| | Arc Voltage | 30 V | 30 V |
| | Welding Current | 220-350 A | 300 A |
| | Welding Speed | 40 cm/min | 20 cm/min |
| | Wire Extension | 20 mm | 20 mm |
| | Welding | Inverter Power Supply | Inverter |
| | Power Supply | | Power Supply |
| | Polarity | DC-electrode Negative | DC-electrode |
| | | (Welding Wire: | Negative |
| | | Negative) | (Welding |
| | | | Wire: |
| | | | Negative) |

1. A welding wire for carbon dioxide arc welding in DC-electrode negative characterized by containing 0.003 to 0.20% by mass of C, 0.05 to 2.5% by mass of Si, 0.25 to 3.5% by mass of Mn, 0.015 to 0.100% by mass of rare-earth elements, 0.001 to 0.05% by mass of P, 0.001 to 0.05% by mass of S, and Fe and unavoidable impurities as residue.

2. The welding wire for the carbon dioxide arc welding in DC-electrode negative in claim 1, wherein the wire further contains 0.0100% by mass or less of O.

3. The welding wire for carbon dioxide arc welding in DC-electrode negative in claim 1 or 2, wherein the wire further contains 0.0008% by mass or less of Ca.

4. The welding wire for the carbon dioxide arc welding in DC-electrode negative in claim 1 or 2, wherein the wire further contains one or two or more of 0.02 to 0.50% by mass of Ti, 0.02 to 0.50% by mass of Zr, and 0.02 to 3.00% by mass of Al.

5. The welding wire for the carbon dioxide arc welding in DC-electrode negative in claim 1 or 2, wherein the wire further contains 0.0001 to 0.0150% by mass of K.

6. The welding wire for the carbon dioxide arc welding in DC-electrode negative in claim 1 or 2, wherein the wire further contains 3.0% by mass or less of Cr, 3.0% by mass or less of Ni, 1.5% by mass or less of Mo, 3.0% by mass or less of Cu, 0.015% by mass or less of B, 0.20% by mass or less of Mg, 0.5% by mass or less of Nb, 0.5% by mass or less of V, and 0.020% by mass or less of N.

7. The welding wire for the carbon dioxide arc welding in DC-electrode negative in claim 3, wherein the wire further contains one or two or more of 0.02 to 0.50% by mass of Ti, 0.02 to 0.50% by mass of Zr, and 0.02 to 3.00% by mass of Al.

8. The welding wire for the carbon dioxide arc welding in DC-electrode negative in claim 3, wherein the wire further contains 0.0001 to 0.0150% by mass of K.

9. The welding wire for the carbon dioxide arc welding in DC-electrode negative in claim 4, wherein the wire further contains 0.0001 to 0.0150% by mass of K.

10. The welding wire for the carbon dioxide arc welding in DC-electrode negative in claim 3, wherein the wire further contains 3.0% by mass or less of Cr, 3.0% by mass or less of Ni, 1.5% by mass or less of Mo, 3.0% by mass or less of Cu, 0.015% by mass or less of B, 0.20% by mass or less of Mg, 0.5% by mass or less of Nb, 0.5% by mass or less of V, and 0.020% by mass or less of N.

11. The welding wire for the carbon dioxide arc welding in DC-electrode negative in claim 4, wherein the wire further contains 3.0% by mass or less of Cr, 3.0% by mass or less of Ni, 1.5% by mass or less of Mo, 3.0% by mass or less of Cu, 0.015% by mass or less of B, 0.20% by mass or less of Mg, 0.5% by mass or less of Nb, 0.5% by mass or less of V, and 0.020% by mass or less of N.

12. The welding wire for the carbon dioxide arc welding in DC-electrode negative in claim 5, wherein the wire further contains 3.0% by mass or less of Cr, 3.0% by mass or less of Ni, 1.5% by mass or less of Mo, 3.0% by mass or less of Cu, 0.015% by mass or less of B, 0.20% by mass or less of Mg, 0.5% by mass or less of Nb, 0.5% by mass or less of V, and 0.020% by mass or less of N.

13. A carbon dioxide arc welding method characterized in that weld is performed in DC-electrode negative with shielding an arc point using a mixed gas comprising mixed gas of Ar gas and a mixing ratio of 60% by volume or more of CO₂ gas or a 100% by volume of CO₂ gas, and using the welding wire for the carbon dioxide arc welding containing 0.003 to 0.20% by mass of C, 0.05 to 2.5% by mass of Si, 0.25 to 3.5% by mass of Mn, 0.015 to 0.100% by mass of rare-earth elements, 0.001 to 0.05% by mass of P, 0.001 to 0.05% by mass of S, and Fe and the unavoidable impurities as the residue.

14. The carbon dioxide arc welding method in claim 13, wherein composition of the welding wire further contains 0.0100% by mass or less of O.

15. The carbon dioxide arc welding method in claim 13 or 14, wherein the composition of the welding wire further contains 0.0008% by mass or less of Ca.

16. The carbon dioxide arc welding method in claim 13 or 14, wherein the composition of the welding wire further contains one or two or more of 0.02 to 0.50% by mass of Ti, 0.02 to 0.50% by mass of Zr, and 0.02 to 3.00% by mass of Al.

17. The carbon dioxide arc welding method in claim 13 or 14, wherein the composition of the welding wire further contains 0.0001 to 0.0150% by mass of K.

18. The carbon dioxide arc welding method in claim 13 or 14, wherein the composition of the welding wire further contains 3.0% by mass or less of Cr, 3.0% by mass or less of Ni, 1.5% by mass or less of Mo, 3.0% by mass or less of Cu, 0.015% by mass or less of B, 0.20% by mass or less of Mg, 0.5% by mass or less of Nb, 0.5% by mass or less of V, and 0.020% by mass or less of N.

19. The carbon dioxide arc welding method in claim 15, wherein the composition of the welding wire further contains one or two or more of 0.02 to 0.50% by mass of Ti, 0.02 to 0.50% by mass of Zr, and 0.02 to 3.00% by mass of Al.

20. The carbon dioxide arc welding method in claim 15, wherein the composition of the welding wire further contains 0.0001 to 0.0150% by mass of K.

21. The carbon dioxide arc welding method in claim 16, wherein the composition of the welding wire further contains 0.0001 to 0.0150% by mass of K.

22. The carbon dioxide arc welding method in claim 15, wherein the composition of the welding wire further contains 3.0% by mass or less of Cr, 3.0% by mass or less of Ni, 1.5% by mass or less of Mo, 3.0% by mass or less of Cu, 0.015% by mass or less of B, 0.20% by mass or less of Mg, 0.5% by mass or less of Nb, 0.5% by mass or less of V, and 0.020% by mass or less of N.

23. The carbon dioxide arc welding method in claim 16, wherein the composition of the welding wire further contains 3.0% by mass or less of Cr, 3.0% by mass or less of Ni, 1.5% by mass or less of Mo, 3.0% by mass or less of Cu, 0.015% by mass or less of B, 0.20% by mass or less of Mg, 0.5% by mass or less of Nb, 0.5% by mass or less of V, and 0.020% by mass or less of N.

24. The carbon dioxide arc welding method in claim 17, wherein the composition of the welding wire further contains 3.0% by mass or less of Cr, 3.0% by mass or less of Ni, 1.5% by mass or less of Mo, 3.0% by mass or less of Cu, 0.015% by mass or less of B, 0.20% by mass or less of Mg, 0.5% by mass or less of Nb, 0.5% by mass or less of V, and 0.020% by mass or less of N.
